(19) United States
(12) Patent Application Publication
(10) Pub. No.: US 2002/0122933 A1
(43) Pub. Date: Sep. 5, 2002

(54) Easily-peelable film

(75) Inventors: Hiroaki Takahata, Toyonaka-shi (JP); Yasuyuki Takagi, Toyonaka-shi (JP)

Correspondence Address: SUGHRUE MION, PLLC, 2100 Pennsylvania Avenue, NW, Washington, DC, 20037-3213, US

(73) Assignee: SUMITOMO CHEMICAL COMPANY, LIMITED

(21) Appl. No.: 09/987,163

(22) Filed: Nov. 13, 2001

(30) Foreign Application Priority Data
Nov. 24, 2000 (JP) 2000-357359

(51) Int. Cl. B32B 1/08; B32B 1/00; B32B 7/12; B32B 15/04

(52) U.S. Cl. 428/332

(57) ABSTRACT

An object of the present invention is to provide an easily-peelable film which has the better easy peelability required for a lid member for a container comprising a polyester resin and in which a sealing layer does not cause stringing upon peeling. There is provided an easily-peelable film having a sealing layer of the thickness of 1 to 20 μm comprising a polyester resin, and a layer adjacent to the sealing layer and comprising at least one kind of ethylene copolymer selected from the group consisting of an ethylene/unsaturated carboxylic ester copolymer and an ethylene vinyl acetate copolymer.

### FIELD OF THE INVENTION

The present invention relates to an easily-peelable film which is suitably used as a lid member for packaging containers.

### BACKGROUND OF THE INVENTION

In packaging forms for sealing an opening of a container such as cup, bowl and tray with a lid member comprising a film, it is required that the lid member can protect the contents of a container and the lid member is easily peelable for opening. As a lid member satisfying such the requirements, an easily-peelable film is used. Previously, a variety of easily-peelable films composed of a resin composition of different resins are known.

As a film having the easy peelability for a container made of a polyester resin, for example, an easily-peelable film is known which is obtained by successively laminating a heat-sealable polyester resin layer, an olefin-maleic anhydride copolymer layer and a polyolefin layer and in which peeling occurs between the heat sealable polyester layer and the olefin/maleic anhydride copolymer layer (JP-A 4-94933). However, the phenomenon in which a part of a heat-sealable polyester resin layer as a sealing layer remains in a string-like manner on an edge of a container after peeling (so-called stringing) is caused sometimes, and, thus, improvement of suppressing so-called stringing is demanded. Other films have insufficient adhesion and peeling properties for containers made of polyester resin.

### SUMMARY OF THE INVENTION

An object of the present invention is to provide an easily-peelable film which has the better easy peelability required as a lid member for a container made of a polyester resin and in which a sealing layer does not cause stringing at peeling.

Under such the situation, the present inventors found that a film having a sealing layer of a particular thickness comprising a polyester resin and a layer comprising a particular ethylene copolymer adjacent to the sealing layer satisfies the aforementioned requirements, and the present invention was completed.

Thus, the present invention is an easily-peelable film, which comprises a sealing layer having the thickness of 1 to 20 μm and comprising a polyester resin, and a layer adjacent to the sealing layer and comprising at least one kind of ethylene copolymer selected from the group consisting of an ethylene/unsaturated carboxylic ester copolymer and an ethylene/vinyl acetate copolymer.

### BRIEF DESCRIPTION OF DRAWINGS

FIG. 1 is a schematic view showing a peeling process for an easily-peelable film of the present invention which is applied to an adherend.

### EXPLANATION OF REFERENCE NUMERALS

1: easily-peelable film

11: non-applying part

12: applying part

13: part to be applied

2: sealing layer

3: ethylene copolymer layer

4: adherend

### DETAILED DESCRIPTION OF THE INVENTION

The seeling layer in the easily-peelable film of the present invention is a layer which is welded to a container made of a polyester resin, constitutes one surface of the easily-peelable film, and comprises a polyester resin.

The polyester resin is a resin obtained by polycondensing a polybasic acid and a multivalent alcohol. Examples of the polybasic acid include aromatic dicarboxylic acids such as terephthalic acid, isophthalic acid, 2,6-naphthalene dicarboxylic acid and the like and aliphatic dicarboxylic acids such as adipic acid. Examples of the multivalent alcohol include diols such as ethylene glycol, 1,4-butanediol, 1,4-cyclohexanedimethanol, pentaethylene glycol, 2,2-dimethyltrimethylene glycol, hexamethylene glycol, neopentyl glycol and the like. The aforementioned polybasic acids and multivalent alcohols are used in an arbitrary combination.

More specifically, examples thereof include terephthalic acid/ethylene glycol copolymer, terephthalic acid/ethylene glycol/1,4-cyclohexanedimethanol ter-polymer, 2,6-naphthalenedicarboxylic acid/ethylene glycol copolymer, terephthalic acid/1,4-butanediol copolymer and the like. From a viewpoint of the low temperature sealability to a polyester container, terephthalic acid/ethylene glycol/1,4-cyclohexanedimethanol ter-polymer is preferable.

The thickness of the sealing layer is 1 μm or greater from a viewpoint of the sealing strength to an adherend (container), preferably 3 μm or greater. From a viewpoint that the sealing layer is smoothly broken at peeling and stringing is prevented from occurring, the thickness is 20 μm or smaller, preferably 10 μm or smaller.

A layer adjacent to the sealing layer comprises at least one kind of ethylene copolymer selected from the group consisting of ethylene/unsaturated carboxylic ester and ethylene/vinyl acetate copolymer. Examples of ethylene/unsaturated carboxylic ester include ethylene/methyl acrylate copolymer, ethylene/methyl methacrylate copolymer, ethylene/ethyl acrylate copolymer, ethylene/ethyl methacrylate copolymer, ethylene/n-butyl acrylate copolymer, ethylene/n-butyl methacrylate copolymer and the like. Among them, from a viewpoint of prevention of stringing for a sealing layer, ethylene/unsaturated carboxylic ester copolymer is preferable and, in particular, ethylene/methyl acrylate copolymer and ethylene/methyl methacrylate copolymer are preferable.

From a viewpoint of a strength between the sealing layer and the adjacent ethylene copolymer layer, it is preferable that the ethylene content in the ethylene copolymer is 50 to 85% by weight. When the content is in the above range, stringing of the sealing layer hardly occur. The ethylene content in the ethylene copolymer is particularly preferably 60 to 80% by weight.

The layer adjacent to the sealing layer may contain, in addition to the ethylene copolymer, a polyethylene resin such as low density polyethylene, linear low density polyethylene and high density polyethylene, a polypropylene resin such as polypropylene and propylene-α-olefin copolymer, a polystyrene resin, a polyamide resin, and a polyester resin.

The ethylene copolymer which constitutes the layer adjacent to the sealing layer may contain compatibilizing agent, rubricant, anti-blocking agent, anti-static agent, antioxidant, thermal stabilizing agent, ultraviolet absorbing agent, antibacterial agent and anti-fogging agent, as necessary.

A substrate layer as described below may be provided on the other side of a layer which is adjacent to the sealing layer and comprises the ethylene copolymer.

Examples of the substrate layer include resin films comprising a thermoplastic resins such as biaxially oriented polyester film, biaxially oriented polyamide film, biaxially oriented polypropylene film and biaxially oriented ethylene/vinyl alcohol copolymer film, and printed films, painted films and deposited films resulting from them. In addition, aluminium foil and paper are applicable. A material for the substrate layer may be selected depending upon the properties required to a lid member, when an easily-peelable film is used for the lid member.

In addition, between the ethylene copolymer layer adjacent to the sealing layer and substrate layer, or between substrate layers when 2 or more substrate layers are used, a layer comprising a thermoplastic resin may be used as adhesive layer. Examples of the thermoplastic resin used for this purpose include a propylene homopolymer such as a polypropylene resin and ethylene-propylene copolymer, a polyethylene resin such as linear low density polyethylene and low density polyethylene, and ethylene copolymers such as ethylene-unsaturated carboxylic ester and ethylene/vinyl acetate. As the ethylene copolymer, in particular, a copolymer having the ethylene content of 85 to 98% by weight is preferably.

The thickness of the easily-peelable film of the present invention is not particularly limited, but 10 to 100 μm is preferable from a viewpoint of easy handling.

The easily-peelable film of the present invention can be manufactured by a molding method such as inflation molding method, T-die casting molding method, extrusion laminate molding method, coextrusion inflation molding method, coextrusion T-die casting molding method and coextrusion laminate molding method.

The ethylene copolymer layer adjacent to the sealing layer and the substrate layer may be laminated by a laminating method such as extruding laminating method and dry laminating method. For example, lamination with an aluminium foil can be performed below. First, the surface of a pre-formed layer comprising the ethylene copolymer is treated by corona treatment and, on the other hand, the surface of the aluminium foil is coated with an adhesive. Then, the treated surface of the ethylene copolymer layer and that of the aluminium foil are piled up so as to face each other, pressed by, for example, a dry laminator, and subjected to aging.

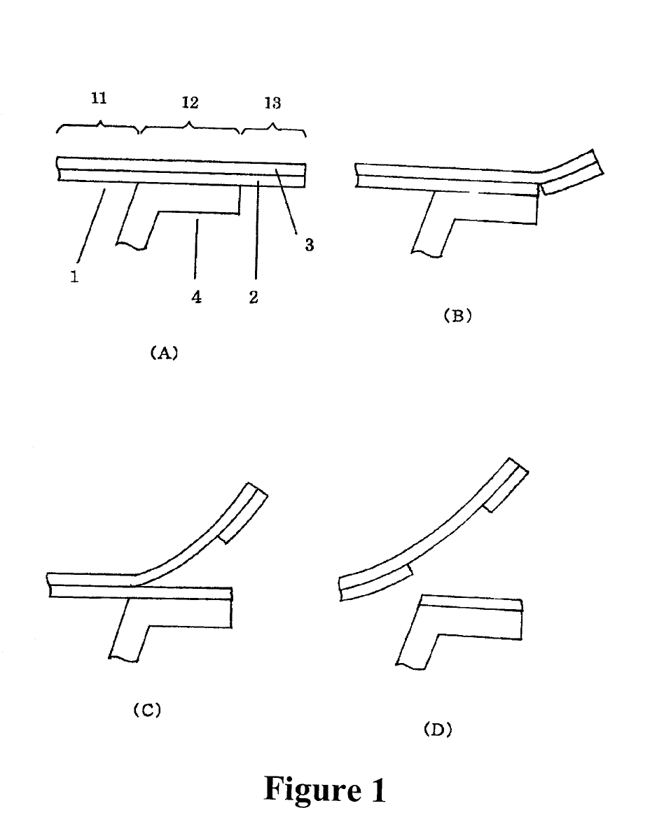

The easily-peelable film of the present invention can be suitably used as a lid member for polyester resin containers. More particularly, the sealing layer of the easily-peelable film and a flange part of a container are piled up, the energy such as heat is acted on the piled up part to seal them, which is used as a lid member for containers. When the easily-peelable film of the present invention applied to an adherend, for example, a polyester resin container is peeled from the adherend. peeling occurs between a sealing layer 2 and an ethylene copolymer layer 3 adjacent to the sealing layer in an area where an adherend 4 and an easily-peelable film 1 are applied (applied part), rupture of a sealing layer 2 occurs near the boundary between the applied part 12 and non-applied part 11, 13, as shown in FIGS. 1(A)-(D).

### EXAMPLES

The present invention will be explained by way of Examples below, but is not limited to them.

(1) Easy Peelability

A sealing layer of a test film is stuck to an amorphous polyester sheet (manufactured by Toyobo Co., Ltd.: A560GE0R, thickness=300 μm) which had been cut into 70 mm×90 mm, and they are heat-sealed into a belt having the width of 20 mm under conditions of pressure: 3 kg/cm² (2.94×10² k Pa) , press time: 1 second, and temperature shown in Table 1, so that a longitudinal direction of the belt is parallel with a side of 90 mm of the polyester seat. This laminated sheet was cut in a direction vertical to a longitudinal direction of the belt-like sealing part, into 15 mm width, to obtain a test piece of 15 mm×70 mm strip.

This test strip was 180 degree-peeled at a tensile rate of 300 mm/min. using an autograph AGS-500 type tensile tester manufactured by Shimadzu Corporation, and the peeling strength thereupon was measured. The results are shown in Table 1.

(2) Stringing

After the above easy peelability test (1), a sealed part of the polyester sheet was observed with naked eyes. The results are shown in Table 1.

### Example 1

A terephthalic acid/ethylene glycol/cyclohexanedimethanol ter-copolymer (manufactured by Eastman Chemical: PHTG6763) was used for a sealing layer, and an ethylene/methyl acrylate copolymer (manufactured by Sumitomo Chemical Co., Ltd.; Acryft CG4002, ethylene content 69% by weight) was used for a layer of an ethylene copolymer adjacent to the sealing layer. In addition, an ethylene/vinyl acetate copolymer (manufactured by Sumitomo Chemical Co., Ltd.: Evatate T3022, ethylene content :93% by weight) was used as a layer which is between the sealing layer and the ethylene copolymer layer and joins both layers (hereinafter, referred to as laminate layer). These three kinds of resins were coextruded with a three layers coextruding T die manufactured by Chugai Tec K. K. so that the thickness of the sealing layer, that of the ethylene copolymer layer and that of the laminate layer were 5 μm, 10 μm or 20 μm, respectively, which resulted in a laminated film.

Thereafter, the exposed surface of the laminate layer was subjected to corona treatment, and dry-laminated with a biaxially oriented polyester film (manufactured by Toyobo Co., Ltd.: Toyobo ester film E5102, thickness: 12 μm). For dry-laminating, an aliphatic ester adhesive (main agent=trade name “Takeluck A515” manufactured by Takeda Chemical Industries, Ltd.; curing agent=trade name “Takenate A50” manufactured by Takeda Chemical Industries, Ltd.) was used.

The evaluation results are shown in Table 1.

TABLE 1

| | | | | |
|---|---|---|---|---|
| Sealing temperature (° C.) | 130 | 140 | 160 | 180 |
| Peeling strength (N/15 mm) | 3.82 | 4.81 | 6.67 | 8.04 |
| Presence or absence of stringing | None | None | None | None |

When the easily-peelable film of the present invention is used as a lid member for a container, in particular, a polyester resin container, stringing of a sealing layer of a lid member does not occur upon opening by peeling, which allows smooth opening.

What is claimed is:

1. An easily-peelable film, which comprises a sealing layer having the thickness of 1 to 20 μm comprising a polyester resin, and a layer adjacent to the sealing layer and comprising at least one kind of ethylene copolymer selected from the group consisting of an ethylene/unsaturated carboxylic ester copolymer and an ethylene/vinyl acetate copolymer.

2. The easily-peelable film according to claim 1, wherein the ethylene content in the ethylene copolymer is 50 to 85% by weight.

3. The easily-peelable film according to claim 1, wherein the layer adjacent to the sealing layer is a layer comprising an ethylene/unsaturated carboxylic ester copolymer.

4. The easily-peelable film according to claim 3, wherein the ethylene/unsaturated carboxylic ester copolymer is an ethylene-methyl acrylate copolymer or an ethylene-methyl methacrylate copolymer.

5. The easily-peelable film according to claim 1, wherein the thickness of the sealing layer is 3 to 10 μm.

6. A lid member comprising the easily-peelable film as defined in claim 1.

7. A packaging body comprising lid member as defined in claim 6.
